(19) United States
(12) Patent Application Publication
(10) Pub. No.: US 2003/0140503 A1
(43) Pub. Date: Jul. 31, 2003

(54) Powered, ground care, tool system

(76) Inventor: Orlando Jerez, Kenner, LA (US)

Correspondence Address: C. Emmett Pugh, Pugh/Associates, Patent & Trademark Attorneys, 82 N. Main St., Suffield, CT, 06078-2102, US

(21) Appl. No.: 09/909,032

(22) Filed: Jul. 19, 2001

Related U.S. Application Data
(63) Continuation-in-part of application No. 09/885,374, filed on Jun. 19, 2001, now abandoned.
Application No. 09/885,374 is a continuation of application No. 09/246,039, filed on Feb. 5, 1999, now Pat. No. 6,247,539.

(51) Int. Cl. B26B 7/00

(52) U.S. Cl. 30/276

(57) ABSTRACT

Implements for attaching to a hand-held, powered device (e.g., “Weed-Eater” type with extended handle or hand tool) to perform various work or chores (filament cutting, blade cutting, brushing, blowing, mixing, etc.). After disconnecting the device's original implement, an initial, cultivator/cutter implement (10), cylindrical in shape with a substantially solid, circular top (12) and a relatively thin, continuous wall of constant thickness, is attached by an appropriate threaded member (e.g. a nut or bolt, usually with one or more washers) to the bottom end of the powered device (FIGS. 1A-D, 29) through a central opening (13/313). The cultivator's top can include a series of circumferentially spaced, “snap-in” openings (14; e.g. two or more) through and into which other implements (e.g. those of FIGS. 3-20) can be attached (FIGS. 2A & B) with the use of a like number of upwardly extending, “snap” legs (21a & b), the adapter then functioning as a “universal” adapter for changing in and out various work implements as desired by the user, with a quick and easy removal and addition of an implement with “snap-out”/“snap-in,” twist actions. The cultivator/adaptor also includes a series of circumferentially spaced, inwardly offset protrusions (16/316) extending down from the circular side wall bottom (15/315), which protrusions dig into and cultivate the ground, removing undesirable vegetation when rotated by the powered device. Side hole sets (17/317) are provided for adding cutting filament sections (18) for supplemental or alternative filament cutting of the “Weed-Eater” type. A protective bottom plate member is also disclosed (FIG. 28).

### RELATED PATENTS

This application relates to some of the same subject matter as the inventor's prior U.S. Pat. No. 5,491,963, issued Feb. 20, 1996, entitled “Garden Cleaning Implement for Cutting/Macerating Weeds Above & Below the Ground,” and U.S. Pat. No. 5,651,418, issued Jul. 29, 1997, entitled “Convertible, User-Supported, Garden Cleaning Implement For Cutting/Macerating Weeds and Like,” the disclosures of which are incorporated herein by reference. This application is a continuation-in-part of Ser. No. 09/885,374 filed Jun. 19, 2001 entitled “Powered, Rotary Tool System” which in turn is a continuation of Ser. No. 09/246,039 filed Feb. 5, 1999 entitled “Cultivator Implement with Castellated Cultivating Protrusions and Multi-Implement, Powered, Cultivation System” being issued as U.S. Pat. No. 6,247,539 on Jun. 19, 2001.

### TECHNICAL FIELD

The present invention relates to, for example, a hand-held, powered tool either with a very long handle or of a compact, hand-gun-like design or the like, for doing various chores, mostly garden-related, generally characterized in the long handled version as a “Weed-Eater” type of device or in the “hand-gun-like version as a “power drill” type device, as well as to other rotary drives, including hand-held devices such as powered hand-held rotary drives or power drills such as those that are used to drive drills, screws and the like, as well as perform other types of work with a change of heads or tool ends. In one aspect of the present invention, it is initially directed in particular to a basic, unique garden cultivator implement for such a device and also preferably to one which includes supplemental means for doing filament line cutting as well. The present invention further relates to a powered, user-two-hand-held, long handle, garden cleaning device or unit which is used to remove weeds and the like out of, for example, a garden, and more particularly to such a garden cleaning implement which has a relatively rigid, rotating member allowing for protective cutting of, for example, weeds and the like immediately adjacent to, for example, desirable vegetation without damaging the vegetation, while also allowing the cultivator implement to be lowered down into the ground for cultivating the soil and macerating the weed roots.

The invention is further directed to a sub-system which includes a “universal” attachment or adapter interface by which a number of different work implements can be easily and quickly attached to the hand-held, powered tool for doing different types of work, depending on the particular implement the user attaches to the powered tool. The invention is further directed to various, unique implements for use on a hand-held, powered device of the “Weed-Eater” type or power drill type or other rotary drive to do different types of work.

A further aspect of the invention is to provide a rotary macerator or cultivator type tool implement with easily changeable metal or other hard material blades. A still further aspect of the invention is directed to a protector or blocking plate to be added to, for example, a macerator or cultivator type tool implement which, for example, also has filament cutters, to keep the macerator or cultivator tines from being active or being able to dig into the ground while using the filament cutters, if so desired.

### BACKGROUND ART

The following is a list of patents which may be of interest for general background information:

| Patent No. | Inventor(s) | Issue Date |
|---|---|---|
| 3,129,771 | Lidstone | 21 Apr. 1964 |
| 4,242,794 | Peterson | 6 Jan. 1981 |
| 4,286,675 | Tuggle | 1 Sep. 1981 |
| 4,501,332 | Straayer | 26 Feb. 1985 |
| 4,856,194 | Lee | 15 Aug. 1989 |
| 4,862,682 | Wait et al | 5 Sep. 1989 |
| 5,345,788 | Jerry | 13 Sep. 1994 |
| 5,361,570 | Bernardy | 8 Nov. 1994 |
| 5,426,852 | Macomber | 27 Jun. 1995 |
| 5,430,943 | Lee | 11 Jul. 1995 |
| 5,491,963 | Jerez | 20 Feb. 1996 |
| 5,493,783 | Oostendorp | 27 Feb. 1996 |
| 5,615,543 | Caffey, et al | 1 Apr. 1197 |
| 5,617,636 | Taggert, et al | 8 Apr. 1997 |
| 5,622,035 | Kondo, et al | 22 Apr. 1997 |
| 5,651,418 | Jerez | 29 Jul. 1997 |
| 5,722,172 | Walden | 3 Mar. 1998 |
| 5,761,892 | Quiroga | 9 Jun. 1998 |
| 6,038,842 | Quiroga | 21 Mar. 2000 |
| 6,247,539 | Jerez | 19 Jun. 2001 |

With respect to exemplary, two-hands-held, powered tools with extended handles to which cutters, cultivators or other work implements are attached, note, for example, the prior '418 & '963 patents of the inventor hereof (Jerez), as well the '794 (Peterson), the '852 (Macomber), the '783 (Oostendorp), the Wait et al ('682), the Straayer ('332), and the '636 (Taggert et al) patents, etc. It is further noted that the Lidstone '771 patent, directed to a relatively small, single-hand-held, power drill adaptation, includes a very different cultivator device in comparison to the cultivator implement of the present invention.

With respect to the broad concept of having a long-handle, two-hands-held, powered garden tool system which includes a number of differing work implements, note, for example, the '675 Tuggle patent. With respect to cultivator implements for long-handle, two-hands-held, gardening power tool devices of the general “Weed-Eater” type of device, note, among others, the patents to Straayer ('332) and Wait et al ('682), with the former having a circular type body in the form of a conical section with a continuous, uninterrupted, circular bottom edge.

For an example of a blower attachment, see the '794 (Peterson) patent. With respect to a cylindrically or conically shaped implement with a central opening or bore for attaching the implement to the threaded drive pin of a conventional line trimmer with a nut or bolt and with the former having holes in very thick side wall portions for inserting filament line segments but with the enlarged, side-wall “gussets” inhibiting its use as a cultivator, and the latter being a circular cultivator, note the '543 Caffey, et al and the '332 Straayer patent. The other cited patents includes examples of other types of exemplary attachments or work implements.

However, in this relatively “crowded” art, there are substantial, innovative, “unobvious” differences between the present invention and the prior art, as brought out more fully below. It is believed that the present invention represents an innovative, substantial advance in the prior art and a valuable contribution to the “useful arts.”

### GENERAL SUMMARY DISCUSSION OF INVENTION

It is thus an object of the invention to provide, for example, a hand-held, powered, rotary unit for, for example, gardening use or other uses with, for example, an improved cultivator implement and preferably with an improved, combined cultivator/cutter implement, particularly one in which the cultivator can be safely used as a cultivator next to desired vegetation without damaging that vegetation.

Other tool implements are likewise disclosed and form a part of the present invention. Thus, it is a further, independent object to provide an adapter for quickly and easily adding a multiple number of different work implements and changing one for another, using, for example, a preferred, “snap-in” and twist type, inter-connecting sub-system.

It is still a further, independent object of the present invention to achieve both of the foregoing objects, preferably in a combined structure, including preferably, for example, both the cultivator/cutter potential functions and the adapter function into a single structure.

It is a still another, independent set of objects to provide additional improved implements that allow, for example, the conversion of a standard type, line filament grass/weed cutter of the general “Weed-Eater” type or a powered hand tool, such as a gun-like shaped, powered “drill” type hand tool, into a general work, multi-use tool, while still allowing it to be quickly and easily converted back to, for example, a gardening type tool or unit.

Thus, in the preferred, exemplary embodiments of the present invention, a combined cultivator/cutter implement of the invention is attachable to different ones of exemplary types of prior art, hand-held, powered, rotary devices designed for gardening use using an exemplary, connection sub-system, including preferably a female-threaded-member (e.g. a nut or female threaded end), a male threaded-member (e.g. bolt or male threaded end) and washer combination, or a drill-chuck and shaft combination, varying in its details for different ones of the hand-held powered devices. The preferred cultivator implement preferably includes an at least generally cylindrical body with a curved side wall and a series of downwardly extending, circumferentially spaced, preferably inwardly offset, macerating protrusions, preferably in one embodiment of integrally molded material or alternatively separately made of metal or other hard, long lasting material, extending down from the bottom of the cultivator's cylindrical side walls, which protrusions when separately made and not integrally formed preferably are easily replaceable after extended use.

The main molded body of the device in one embodiment includes circumferentially spaced slots for receiving and holding the separately formed macerating tine blades, made, for example, of stamped metal. The blade tines of this currently more preferred embodiment preferably is curved following the radius of curvature of the cylindrical body and ends in a side cutting tip which is laterally or radially directed. The molded body includes side body protrusions, preferably on both the interior and exterior of the body's side walls to strengthen the side walls of the main body in the areas where the interior slots are located.

When the cultivator implement is rotated by the powered unit, the bottom protrusions serve to dig into the ground, cultivating it and digging it up and macerating any weeds and like undesirable vegetation, while not significantly damaging, if any damage at all, to adjacent vegetation or plants due to their only being a smoothly curved, sidewall contact with the desired vegetation. The cultivator implement preferably also includes circumferentially spaced sets of filament holes into which filament segments can be added with their two ends extending out from each hole set, allowing the cultivator implement also to be used as a supplemental or concurrent “Weed-Eater” filament type cutter. In molding the main body of the combined cultivator/filament-cutter implement, longitudinally extended, circular protrusions preferably are included between each filament hole set to reduce the stress on the filament line (typically made of nylon or other artificial material), adding to the effective life of the line.

This initial cultivator/cutter implement further preferably or alternatively includes “snap-in” type opening for attaching other work implements to the cultivator type, powered device via the cultivator/cutter element then serving as a “universal” adapter.

The cultivator/cutter implement thus preferably or alternatively is also used as a “snap-in” attachment adapter for, for example, at least two, exemplary types of implements—a larger, cylindrically concentric one with multiple “snap” legs, and a smaller, circular, ring or disc-shaped one with multiple “snap” legs, respectively, which represent two, exemplary approaches to general implement design for use in the multi-implement system aspect of the present invention.

Thus, with the foregoing approach, one or more, preferably many, different implements can be quickly and easily attached to a hand-held, powered, rotary device, preferably without tools, in which selected ones of the implements can be used to perform various types of work or chores (filament cutting, blade cutting, edge blade cutting, brushing, blowing, mixing, etc.).

For example, an initial, circular, cultivator/cutter implement, preferably cylindrical in shape preferably with a substantially solid, circular top, can be attached by an appropriate threaded member (e.g. a nut or bolt, usually with one or more washers) or chuck shaft to the bottom end of the hand-held, hand-gun shaped, powered device. The cultivator/cutter implement preferably includes at its top a series of circumferentially spaced, “snap-in” openings (e.g. two or more) through and into which the other work implements can be selectively attached through the use of the selected implement having a like positioned and number of upwardly extending, “snap” legs at the top of the add-on implement(s).

When that implement's work is completed, it can be easily detached by un-snapping the legs from the adapter and removing it from the powered unit to be easily replaced with one of the other, then selected work implements, and so on.

Of course, other types of quick and easy, mechanical or mechanical/magnetic attachment sub-systems besides the preferred “snap-in” twist design could be used, if so desired, such as, for further example, an insert and counter twist (or rotate) type connection, with a threaded engagement or not, etc.

A further exemplary, preferred feature is the inclusion of a flat base, add-on member, preferably of larger diameter than the diameter of the main body of the cultivator, which can be attached to the bottom of the rotary implement, particularly when the implement is the combined cultivator and filament cutter type, for covering over and blocking the cultivator tines from coming into macerating contact with the ground or desired vegetation when the implement is desired for use, for example, purely as a filament cutter device.

The foregoing and additional features and approaches of the present invention further are disclosed and discussed below.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a partial, close-up, cut-away, side view of one of the tines or protrusions of the embodiment of the combined cultivator/cutter of FIGS. 1A-1D.

FIG. 1A-D are perspective, exploded views showing a preferred, exemplary embodiment of a combined cultivator/cutter of the invention being attached to different ones of exemplary types of prior art, hand-held powered devices with an exemplary connection sub-system, including a female-threaded-member (e.g. a nut or female threaded end), a male threaded-member (e.g. bolt or male threaded end) and washer combination, varying in its details for different ones of the hand-held powered devices, a different one of the exemplary powered, hand-held devices being shown in each figure, it being further noted that the cultivator/cutter further includes “snap-in” opening for attaching other work implements to the hand-held powered device via the cultivator/cutter element.

FIG. 2A & 2B are perspective, exploded views of the cultivator/cutter element of FIGS. 1A-D being used as the “snap-in” attachment element for two, exemplary types of implements, a larger, cylindrically concentric one with an exemplary four “snap” legs and a smaller, disc-shaped one with an exemplary two, upwardly extending, “snap” legs, respectively, which represent two, exemplary approaches to general implement design for use in the multi-implement system of the present invention.

FIGS. 3-20 are perspective views of various exemplary implements with upwardly extending, “snap” legs on them (an exemplary two being illustrated) for attaching to the exemplary cultivator/cutter of FIGS. 1A-2B, with FIGS. 4B-7B being side, partial views of the bottom portions of the implements of FIGS. 4-7, respectively, and FIG. 14A being a bottom view of the implement of FIG. 14 and FIG. 14B being a cross-sectional view taken along section lines B-B of FIG. 10-14A.

FIGS. 21A & B are perspective views of the working end of an exemplary, prior art, hand-held, powered, line filament trimmer unit showing the removal of various standard parts of the unit in preparation for adding the cultivator/cutter/“adapter” of FIGS. 1A-D of the present invention.

FIG. 22 is a perspective view showing the altered unit of FIG. 21B, with the addition of cultivator/cutter/“adapter” of FIGS. 1A-D added, in use in doing a gardening chore.

FIGS. 23A & B are perspective views showing the altered unit of FIG. 21B, with the addition of the cultivator/cutter/“adapter” of FIGS. 1A-D added, in use in doing gardening chores, including cultivating and cutting, respectively.

FIGS. 24A & B are perspective views showing the steps involved in adding a line filament segment to the body of the cultivator/cutter implement of FIGS. 1A-D.

FIG. 25 is a top, perspective view of another, alternative, exemplary, preferred embodiment of the cultivator implement of the present invention; while

FIG. 26 is bottom, perspective view of the embodiment of FIG. 25; and

FIG. 27 also is a bottom, perspective view, similar to that of FIG. 26, but with the cultivator tines or protrusions being out of their securement slots and an exemplary one of the exemplary securement screws in an exploded array with dashed lines indicated where the exploded elements are located in the assembled unit, and with the filament line cutters removed for simplicity sake.

FIG. 28 is a top, perspective view of an exemplary embodiment of a wider diameter, bottom protector covering or blocking plate for adding to the bottom of the cultivator implement of, for example, FIGS. 25-27, to prevent, when desired, any possible damage to the ground or desirable vegetation when the cultivator implement is desired to be used only in its filament cutting aspect or other use not involving using the tines or protrusions for macerating or cultivation, with the opposite, un-seen side of the plate preferably being flat and smooth.

FIG. 29 is a side, perspective, exploded view of the initial, exemplary, combined cultivator/filament-cutter embodiment of FIGS. 1-2 with an exemplary fastening assembly for attaching the cultivator to an exemplary, hand-held, rotary powered device (shown in phantom line).

### EXEMPLARY MODES FOR CARRYING OUT THE INVENTION

Various types of two-hand-held, long handle, powered devices, typically for yard or gardening work are well known, a number of which are of the “Weed-Eater” type. A “Weed-Eater” type of device typically uses a rotating spool of filament at its bottom with a feed bumper (note spool 6 and bumper 7 of FIGS. 21A & B) for cutting grass and the like with the end portions of the filament line, as the spool is rotated about a “vertical” axis.

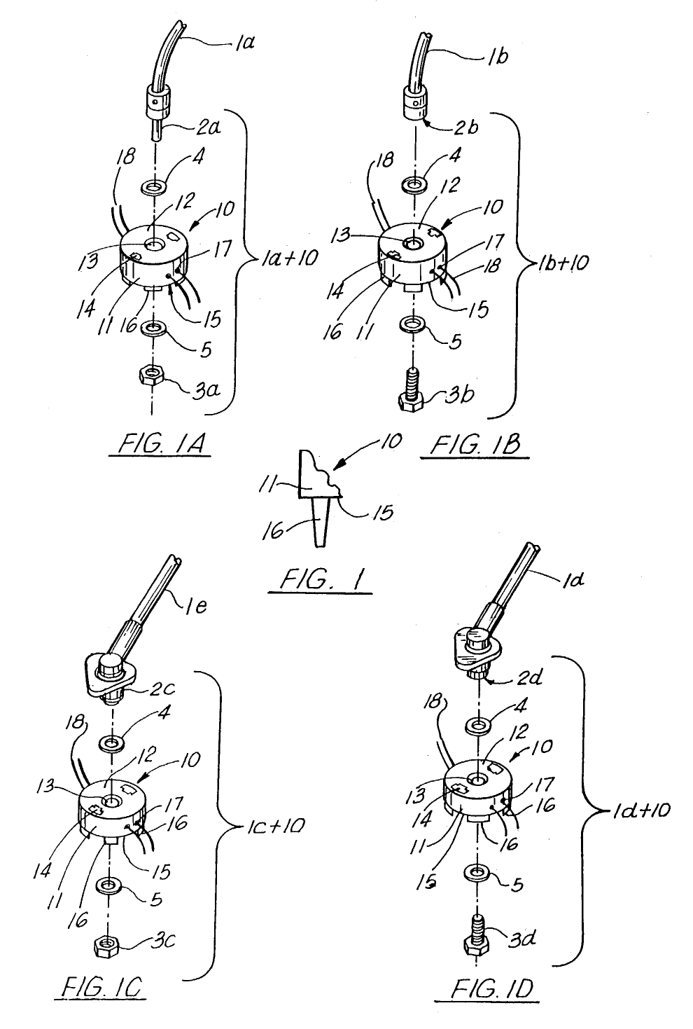

The lengths of the handles of these types of powered devices typically are of the order of a number of feet, typically at least about four to six (4-6′) feet. As can be seen in FIGS. 1A-D, the bottom ends 2a-2d of these types of devices 1a-1d typically include powered, rotatable, end threaded members, either of the male or female type, for attaching, for example, the filament spool or other implement that came with the original, powered device.

Exemplary Cultivator/Adapter 10 (FIGS. 1 & 2)

In the present invention, any implement [e.g. a filament spool, or other type of implement (e.g. note the various implements shown in the above listed patents), etc.] attached to the bottom end (2a-2d) of the hand-held powered device (1a-1d) is removed. Then, as shown in FIGS. 1A-D, an appropriate threaded member 3a-3d, typically either a nut 3a/3c (FIGS. 1A & 1C) or a bolt 3b/3d (FIGS. 1B & ID) with one or more appropriate, top and/or bottom washers 4, 5 are used to connect the exemplary cultivator/cutter implement 10 to the long handle, two-hand-held powered device la-Id.

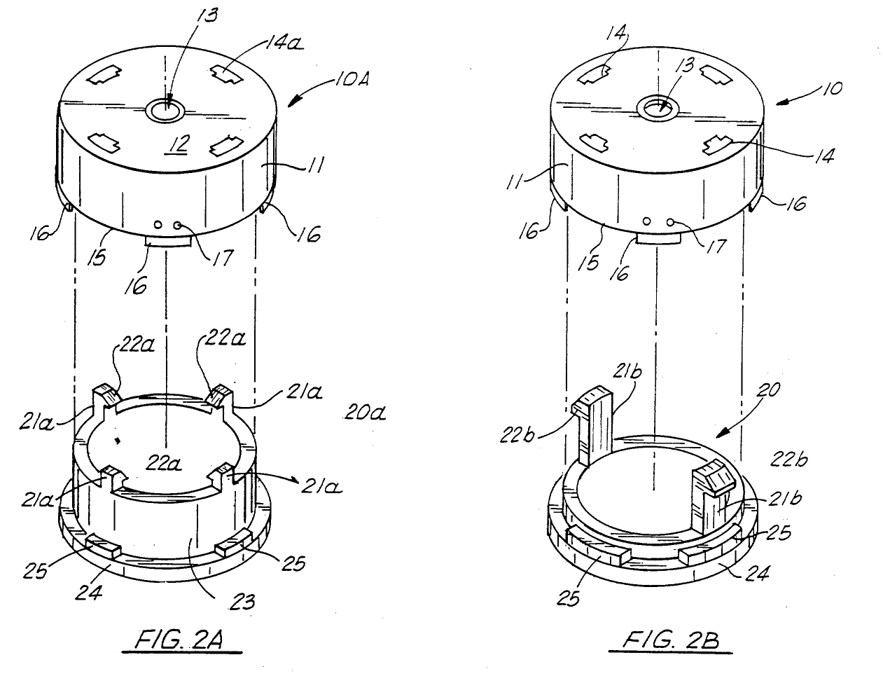

As can be seen in FIGS. 1A-D and FIGS. 2A & B, the cultivator/cutter implement 10 includes a cylindrically shaped body 11 with preferably generally a solid top 12 extending over most of its top with, for example, the exception of the central unit attachment opening 13 and the “snap-in,” “T” shaped openings 14 circumferentially spaced about the periphery of the top 12. Further open areas could be provided in the top 12, if so desired, as long as the top had the necessary structural integrity and strength. Although the body 11 is preferably exactly cylindrical, some flaring of the side wall may occur, for example, in the manufacturing process which causes the body to be substantially cylindrical, but not exactly cylindrical, in its over-all, exterior shape.

The curved side wall of the body 11 preferably is relatively thin, continuous and of constant thickness, although some deviation of the body's side wall is possible as long as the deviation(s) do not significantly impede the movement and penetration of the side wall down into the ground in the implement's cultivator action and as long as the side wall has the necessary structural integrity and strength. Additionally, peripherally spaced about its bottom 15 are a series of spaced, cultivator extensions tines 16, along with a series of dual opening or hole sets 17 through which the ends of cutting filament line segments 18 are placed for cutting functions. The tines 16 form protrusions having exterior side walls inwardly offset a fraction of an inch from the exterior surface of the side wall (FIG. 1). When it is desired to use the implement 10 as a concurrent or separate filament line cutter, an appropriate number of line segments 18 are placed in the hole sets 17 as seen in FIGS. 1A-D, as further discussed below in detail in connection with FIGS. 24A & B.

An exemplary number of four (4) protrusions or tines 16, spaced from each at their centers at the circular body's ninety (90°) degree points, are illustrated, but a different number of them, of course, is possible (note for further example the implement 70 of FIG. 7). The protruding tines 16 generally form a “castellated” configuration with the flat, bottom edge 15 and can have inclined side(s) or a taper to aid in their penetration into the ground, however, preferably they are not so sharp as to cut into a human hand when being handled. In cultivator use, the downwardly directed, circumferentially spaced, protruding tines 16 serve to provide spaced, ground entry and macerating projections, which provide a substantially improved cultivator action in comparison to that achieved by a circular cultivator that has only a single, continuous, entry edge extending without interruption about its three hundred and sixty (360°) degree scope, such as that shown in the Straayer '332 patent. In the exemplary embodiment 10, the four (4), downwardly protruding tines 16 can have an exemplary width of about an inch and a thickness at their bases of about an eighth (⅛″) of an inch, with the body 11 having a diameter of about three and three-quarters (3¾″) inches and a constant wall thickness of about a quarter (¼″) of an inch.

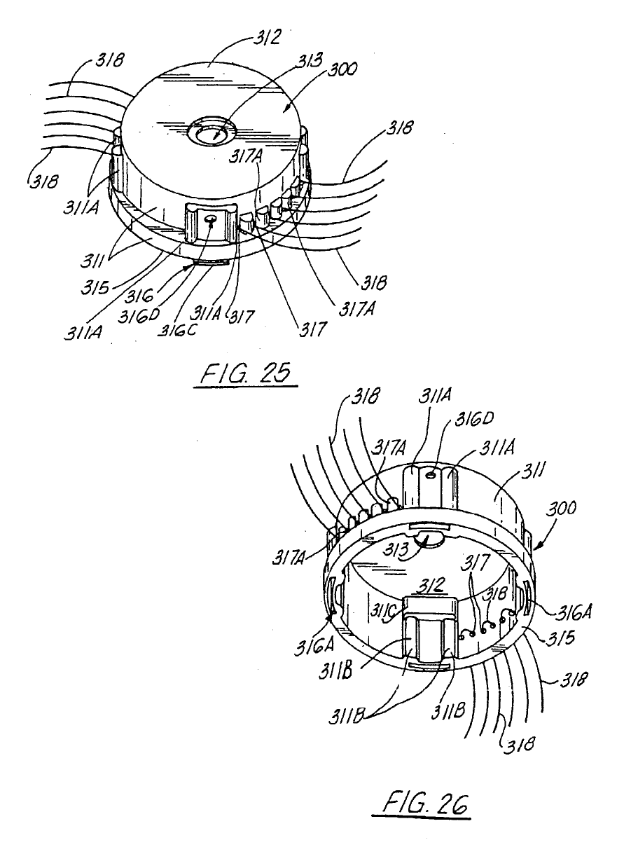

The cylindrical body 11 with its top 12 and protrusions 16 can be made of an integral body of, for example, molded material, as illustrated. Alternatively, it could be made of two, concentric sections with a castellated metal edge sandwiched between them. A still further, exemplary structure would be an integral, cylindrical body (like 11) with spaced slots in its bottom edge (15), with the projecting tines (16) being formed of, for example, metal inserts which are inserted into the slots (note, for example, the alternative embodiment 300 of FIGS. 25-27).

With respect to the spaced, “snap-in” openings 14, typically a multiple number of them are desirable, for example, the two illustrated in FIGS. 1A-D and 2B. If so desired, however, three or four (14a, as illustrated in FIG. 2A) or more circumferentially spaced ones could be used. Whichever number of “snap-in” openings 14/14a are used, there should be a like number of spaced, upwardly extending, “snap” legs 21a/21b used (note FIGS. 2A & 2B).

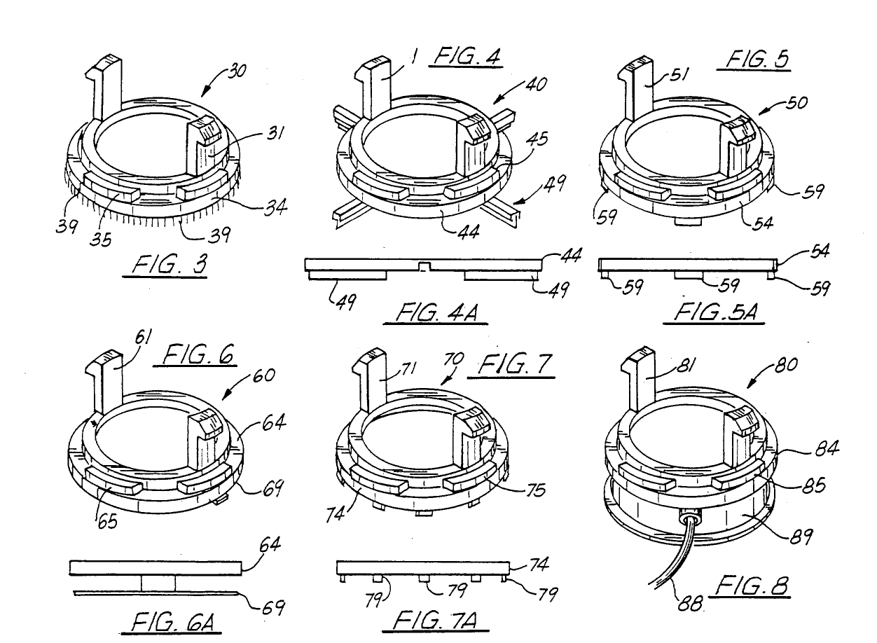

Each “snap” leg 21a/21b can have a bit of lateral flex to it, allowing it to slightly bend, if necessary or desired, and, as can be seen in FIGS. 2A & 2B (as well as in FIGS. 3-20), includes at its distal end a laterally extended latch portion 22a/22b. When the exemplary, generalized implement 20/20a is properly aligned with and brought up into engagement with the cultivator/cutter implement 10/10a, the “snap” legs' distal ends with their latch portions 22a/22b are pushed up through the “T” shaped openings 14/14a with the head or top of the legs lined up with the centrally located, radially directed base or stem of the “T” openings, and, after the latch portions pass completely through the central parts of the “T” openings and are rotated or twisted to one side or the other, the legs 21a/21b of the implement 20/20a snap into locking engagement with the side ends of the “T” openings 14/14a and thus to the cultivator/cutting implement 10/10a.

The cultivator/cutting implement 10 then no longer serves as a working implement but rather is now serves as a “universal” adapter for the other implements, e.g., the generalized implements 20/20a of FIGS. 2A & 2B and those of FIGS. 3-20, to be quickly and easily attached to the hand-held powered device (1a-1d) via the “adapter” 10. Of course, although there is economical advantage to having the cultivator/cutter implement 10 and the “adapter” 10 combined into one and the same structure, the adapter could be designed with a “single use” function, namely, merely as an adapter, if so desired, with the cultivator/cutter implement 10 (presumably without the openings 14) then being connected to the powered device (1a-1d) via the then single function adapter.

With respect to the cultivator/cutter implement 10, it can be made of, for example, metal, plastic or high impact nylon, or the like, etc. The cylindrical body can have an exemplary diameter of about three and three-quarters (3¾″) inches, an outer wall thickness of about a quarter (¼″) of an inch, and a height of about one and three-eights (1⅜″) inches. The central opening 13 can have a diameter of about a quarter (¼″) of an inch, preferably with at least one depression or a series of concentric depressions surrounding it to accept at least one standard size washer or varying diameter washers 4.

The outer, side surfaces of the cultivator tines 16 preferably are off-set back from the circumference of the outer cylindrical surface of the main body 11 of the implement 10 by, for example, a sixteenth (1/16″) of an inch. This off-set reduces, if not prevents, any significant damage to any adjacent plants, walls, and the like, as the tines 16 cut up and macerate the soil in its cultivator function.

Many different implements can be used with the “adapter” 10, and, as previously noted, an exemplary series of them are illustrated in FIGS. 3-20. As shown in FIGS. 2A & 2B, the implements are generally of two types, the first type 20 (FIG. 2B) being smaller in its height and somewhat disc or ring shaped at its bottom portion 24 with relatively long, upwardly extending, “snap” legs 21b, with the 2^{nd} type 20a (FIG. 2A) being larger having a ring bottom 24 and a cylindrical main body 23 extending above (as illustrated in FIG. 2A) or below (see FIG. 8) the ring portion 24. For those of the latter type with an upwardly extending cylindrical body 23, its outer diameter is close to but a little bit less than the inner diameter of the “adapter” 10, allowing it to be slipped inside the adapter but with preferably, face-to-face surface engagement between the respective cylindrical bodies, enhancing the locking engagement between the two (10+20) and adding to their combined stability. The ring portions 24 of each have upper projections which contact and interface with the bottom 15 of the “adapter” 10.

It is noted that, in some implements of the types of FIGS. 2A & 2B, the central interior area and/or the bottom are solid and in others the interior area and/or the bottom are open, depending on the work for which the implement is designed.

Multi-Implements (FIGS. 3-20)

Although not exhaustive of the types of implements that could be used with the “adapter” 10, the implements of FIGS. 3-20 certainly illustrate many examples of the many different types of some of the work implements that can be used in connection with the system of the present invention.

The brush implement 30 of FIG. 3 is of the disc or ring type (somewhat like that of FIG. 2B), with the ring 34 having a closed bottom with series of downwardly directed brush bristles 39 extended about its bottom surface. When attached to the two-hand-held, powered device (1a-1d) via the adapter 10, the brush bristles will be rapidly moved around in circular fashion and can be used for scrubbing, cleaning and other types of brush applications on, for example, a floor or other suitable surface.

It is noted that this implement 30 and some of the following implements have nothing to do with gardening applications and represents the extending out of the application of a “Weed-Eater” type unit to make it a more generalized, powered work tool as well, with a long handle for getting into, for example, out-of-the-way locations and/or while the user is standing up.

The wiper implement 40 of FIG. 4 is of the disc or ring type (somewhat like that of FIG. 2B), with the ring 44 having a series of downwardly extending wiper blades 49 circumferentially spaced and radially extended along its circular periphery. When attached to the two-hand-held, powered device (1a-1d) via the adapter 10, the wiper blades will be rapidly moved around in circular fashion and can be used to wipe water off a floor or the like and for various other wiper applications.

The cultivator implement 50 of FIG. 5 is of the disc or ring type (somewhat like that of FIG. 2B), with the ring 54 having a series of cultivator tines or protrusions 59 downwardly directed and spaced and extended along its circular periphery (similar to tines 16). When attached to the hand-held, powered device (1a-1d) via the adapter 10, the protruding tines 59 will be rapidly moved around in circular fashion and effectively can be used as a replacement for the protruding tines 16 when they wear out, it being noted that the implement 50 substantively duplicates the bottom portion of the body 11 with its tines 16 when “new.”

The cutter implement 60 of FIG. 6 is of the disc or ring type (somewhat like that of FIG. 2B), with the ring 64 having a circular or disc shaped, cutting blade 69 with its cutting edge outwardly directed about its periphery with a diameter equal to or less than that of the ring portion 64, thereby protectively exposing its cutting edge within the ring portion's circular periphery. When attached to the two-hand-held, powered device (1a-1d) via the adapter 10, the cutting blade 69 will be rapidly moved around in circular fashion and can be used for various cutting applications, such as, for example, in place of the cutting/macerating type blade (14) shown in the Jerez '963 patent.

The cultivator implement 70 of FIG. 7 is of the disc or ring type (somewhat like that of FIG. 2B), with the ring 74 having a series of downwardly directed, cultivator tines or protrusions 79 downwardly directed and spaced and extended along its circular periphery, in similar fashion to the protrusions or tines 16, but with more tines of narrower width. When attached to the hand-held, powered device (1a-1d)via the adapter 10, the cultivator tines 79 will be rapidly moved around in circular fashion and can be used in similar fashion to the use of the tines 16 on the cultivator/adapter 10. The implement 70 is thus similar to the bottom part of the implement 10, but with a greater number of smaller tines. Like the implement 50, the implement 70 can be effectively used as a tine replacement when the tines 16 wear out on the body 11.

The filament cutter implement 80 of FIG. 8 is of the cylindrical body type (somewhat like that of FIG. 2A, but extended below the ring portion), with the ring 84 having a lower, cylindrical body 89 which houses a line filament spool and has at its bottom a feed bumper (unseen in FIG. 8, but similar to bumper 7 of FIGS. 21A & B). When attached to the two-hand-held, powered device (1a-1d) via the adapter 10, the line spool in the body 89 will be rapidly moved around in circular fashion and serves as a continuous source of cutting line filament 88 in similar fashion to that of the original unit 1 (see, for example, the spool 6 of FIGS. 21A & B). This implement 80 allows for the powered device to be, in effect, converted back to a line spool type of grass/weed cutter in a quick and easy fashion, without the need for any hand tool(s) or the need to remove or re-apply any threaded members.

The cultivator implement 90 of FIG. 9 is of the disc or ring type (somewhat like that of FIG. 2B), with the ring 94 having a solid bottom and a solid interior with a centrally located, downwardly extended ground cultivator 99 of a totally different design than the peripherally spaced tines 16. The longitudinally extended, centrally located cultivator 99 can have different shapes, with an exemplary, alternative set of five (5) being illustrated in side-by-side, comparative juxtaposition and referenced as 99a, 99b, 99c & 99d. When attached to the two-hand-held, powered device (1a-1d) via the adapter 10, the cultivator 99 will be rapidly rotated and can be used to chew up the ground or the like, or make holes in the ground to ultimately insert plants in, and for various other cultivator applications.

The cultivator implement 100 of FIG. 10 is of the disc or ring type (somewhat like that of FIG. 2B), with the ring 104 having a solid bottom and interior and a centrally located, relatively small, individual weed macerator 109 with an alternative macerator 109a positioned in juxtaposition for comparative purposes. When attached to the two-hand-held, powered device (1a-1d) via the adapter 10, the individual weed macerator 109/109a will be rapidly rotated and, when carefully positioned, can be used to kill and macerate individual weeds and the like and for various other similar applications.

The cultivator implement 110 of FIG. 11 is of the disc or ring type (somewhat like that of FIG. 2B), with the ring 114 having a solid bottom and interior and a centrally located, relatively large, “Archimedes” screw vane 119. When attached to the two-hand-held, powered device (1a-1d) via the adapter 10, the vane 119 will be rapidly rotated and can be used to chew up the ground or the like, or make holes in the ground to ultimately insert plants in, and for various other cultivator applications.

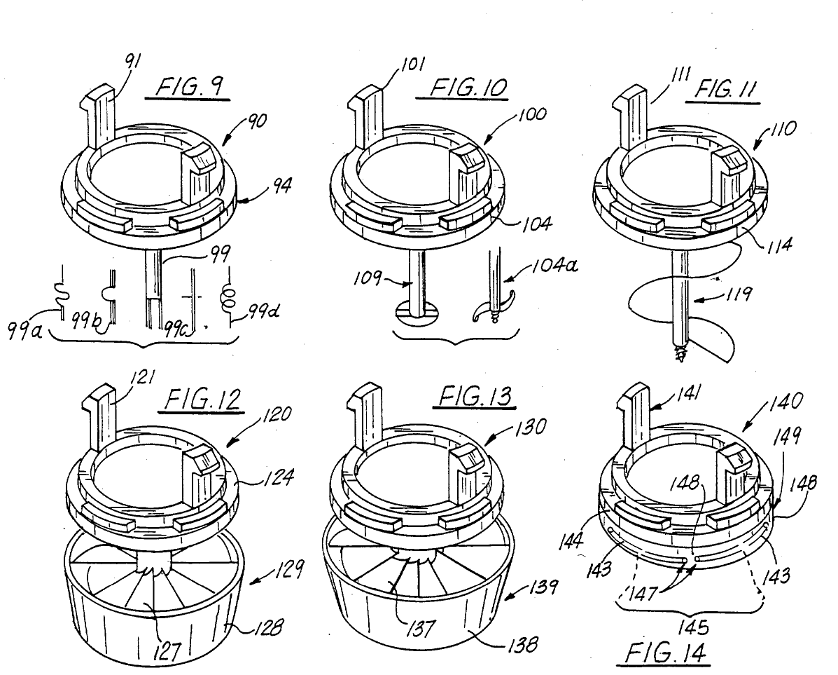

The propeller implement 120 of FIG. 12 is of the disc or ring type (somewhat like that of FIG. 2B), with the ring 124 having an solid bottom and a solid interior and a centrally located, fixed shaft 129 attached thereto and carrying below it a relatively small marine propeller 122 in an attached cowling 123. When attached to the two-hand-held, powered device (1a-1d) via the adapter 10, the shaft 129 and the propeller 122 will be rapidly rotated and can be used as a “kicker” motor for small marine craft and the like.

The blower implement 130 of FIG. 13 is of the disc or ring type (somewhat like that of FIG. 2B), with the ring 134 having a solid bottom and a solid interior and a centrally located, fixed shaft 139 attached thereto and carrying below it a fan 132 in an attached cowling 133. When attached to the two-hand-held, powered device (1a-1d) via the adapter 10, the shaft 139 and the fan blades 132 will be rapidly rotated and can be used, for example, as a blower for blowing and moving about grass cuttings, leaves and the like across the ground, sidewalk, driveway, etc.

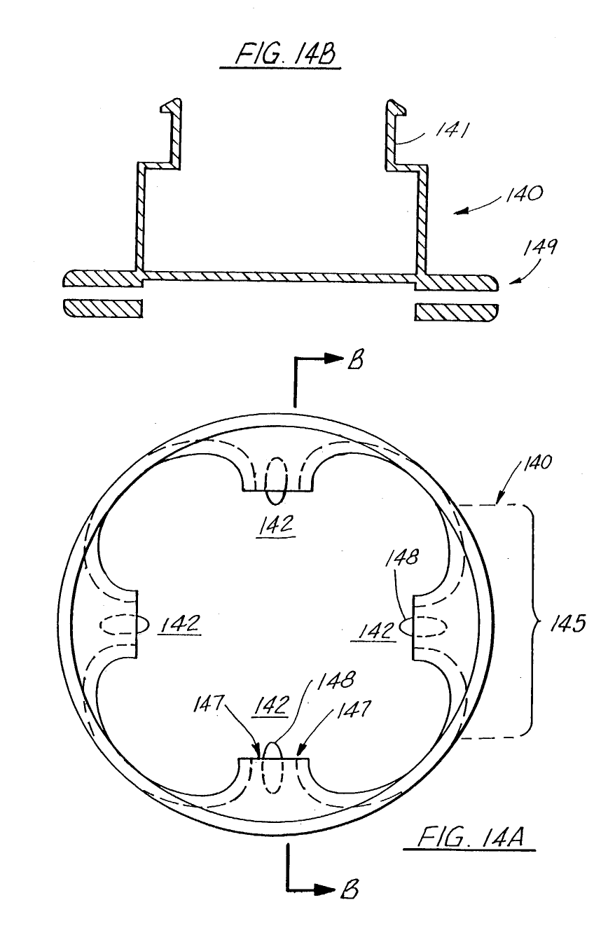

The filament cutter implement 140 of FIGS. 14 and 14A & B is of the disc or ring type (somewhat like that of FIG. 2B), with the ring 144 having a solid bottom and an open interior with cutter filament line placement areas 149 at its bottom portion for use with filament line segments (not illustrated) placed therein and protruding out dual openings 147 at its sides at several (e.g. the four illustrated), equally and circumferentially spaced locations 142. When attached to the two-hand-held, powered device (1a-1d) via the adapter 10, the ring 144 and the filament areas 149 will be rapidly rotated and can be used, for example, as a filament cutter in similar fashion to the filament segments 18 in the holes 17. With respect to the oval, center, line stop member 148, it can be reduced in size, if so desired, so that it can have, for example, the same thickness as the wall thickness and the channel thickness, namely, for example, a quarter (¼″) of an inch.

A substantial advantage to the filament cutter design of the cutter implement 140 is that the contact of the filament line segments with the side wall areas of the implement through out that contact is a graduated, curved contact and not a sharp, ninety (90°) degree, line contact, as for example, occurs in the openings 17.

This all-encompassing curvature of the side wall contact area (note brackets 145) is best seen in FIG. 14A, while the dual, compound curved, side, exterior channels 143 for each filament segment (not illustrated but similar to filament segment 18) is best seen in FIG. 14. However, because of the relatively small scale of FIG. 14, the exterior part of the oval, line holding stop 146 with its curved wall portions can not be well seen but whose curvatures are clearly seen in FIG. 14A.

It is noted that the line segments for the curved openings 147 are inserted and removed in the same general fashion as discussed herein with respect to segments 18 and openings 17. It is noted that, when the implement 140 is spun by the powered device 1a-1d, that part of each line segment that is “up-stream” will fold back over its “down-stream” portion but still will face only curved and not sharp contact with the curved exterior of the stop 146.

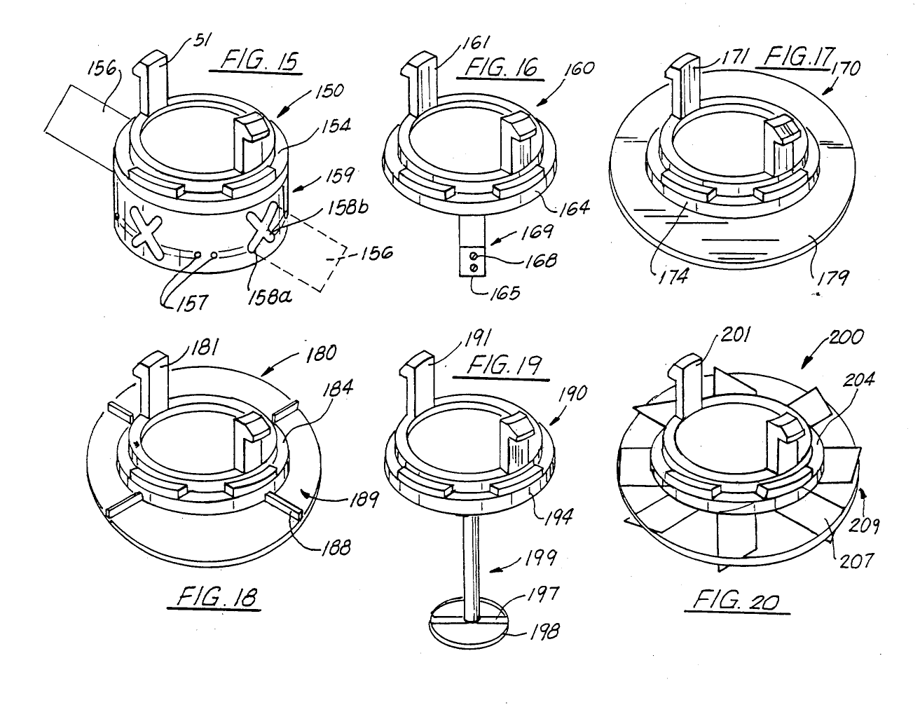

The blower/cutter implement 150 of FIG. 15 is of the cylindrical body type (somewhat like that of FIG. 2A, but extended below the ring portion) with an open bottom and interior, with the ring 154 having a lower, cylindrical body 159 which includes a series of slot sets, a forty-five (45°) degree slot 158a and a mid-intersecting, one hundred and thirty-five (135°), complementary slot 158b. Into these slots 158a or 158b, depending on the direction of rotation of the implement 150, flexible sections of cutting or blower blades 156 are inserted. When attached to the two-hand-held, powered device (1a-1d) via the adapter 10, the blades 156 in the selected set of slots 158a/b will be rapidly moved around in circular fashion and serves as either a cutting blade for vegetation or, more preferably, as blower blades, allowing the implement 150 to be used as a blower to blow and drive cuttings, leaves and other relatively light debris to a desired location or pick-up area.

Additionally, there is also preferably included sets of dual openings 157 at the sides of the cylindrical body 159 at several (e.g. the four illustrated), equally and circumferentially spaced locations, similar in function and design to the openings 147 for the implement 140. When attached to the two-hand-held, powered device (1a-1d) via the adapter 10 and with filament segments (see 18) inserted, the cylindrical body 159, ring 154 and the ends of the filament segments (18) will be rapidly rotated and can be alternatively or concurrently used, for example, as a filament cutter in similar fashion to the filament segments 18 in the holes 17, along with the blower function provided by the blades 156.

The drive implement 160 of FIG. 16 is of the disc or ring type (somewhat like that of FIG. 2B), with the ring 164 having a solid bottom and a solid interior with a centrally located, downwardly extended, connector/drive member 169. The longitudinally extended, centrally located connector/drive member 169 can be used to connect to, for example, the drive shaft of some other device, such as, for example, a small pump (not illustrated but well known in the small pump art) and an exemplary set of screw holes 168 are included for attaching the bottom portion 165 of the member to the other device. When attached to the two-hand-held, powered device (1a-1d) via the adapter 10, the connector/drive member 169 will be rapidly rotated and will rotatably drive the attached device (e.g. a small pump to drain an area or pump water for irrigation, etc.).

The implement 170 of FIG. 17 is of the disc or ring type (somewhat like that of FIG. 2B), with the ring 174 having a solid bottom and a solid interior with a centrally located, circular, fixed, plate member 179. The radially extended, centrally located plate member 179 can be used, for example, to smooth out the ground. Thus, when attached to the two-hand-held, powered device (1a-1d) via the adapter 10, the plate member 179 will be rapidly rotated and then its smooth bottom surface can be used to, for example, smooth out the cultivated ground after, for example, the cultivator 10 was initially used to break up, dig into and cultivate the ground.

The spreader implement 180 of FIG. 18 likewise is of the disc or ring type (somewhat like that of FIG. 2B), with the ring 184 having a solid bottom and a solid interior with a centrally located, circular, flat, fixed, plate member 189, substantively identical to the plate member 179 of FIG. 17, but with a series of radially and upwardly extended plates 188. The radially extended, centrally located plate member 189 with its radial members 188 can be used, for example, as a spreader implement to distribute, for example, seed, fertilizer, etc., about the ground. Thus, when attached to the two-hand-held, powered device (1a-1d) via the adapter 10, the plate member 189 with its radial members 188 will be rapidly rotated and any seed, fertilizer or other material placed on and falling down onto the upper surface of the plate 189 will then be thrown out and distributed about the ground. A supplemental bin attachment (not illustrated) could be attached to the handle of the device 1a-1d with, for example, a bottom funnel opening extending down to the central or middle portion of the upper side of the plate 189 for feeding the seed, fertilizer or other material unto the upper surface of the plate for distribution about the ground.

The mixer implement 190 of FIG. 19 is of the disc or ring type (somewhat like that of FIG. 2B), with the ring 194 having a solid bottom and a solid interior with a centrally located, downwardly extended, mixer member 199. The longitudinally extended, centrally located mixer member 199 has a bottom ring 198 which surrounds and supports a mixer blade 197 and can be used to mix various fluent or liquid materials. When attached to the two-hand-held, powered device (1a-1d) via the adapter 10, the mixer member 199 with its mixer blade 197 and ring 198 will be rapidly rotated and can be used to mix together such materials as concrete making materials, etc.

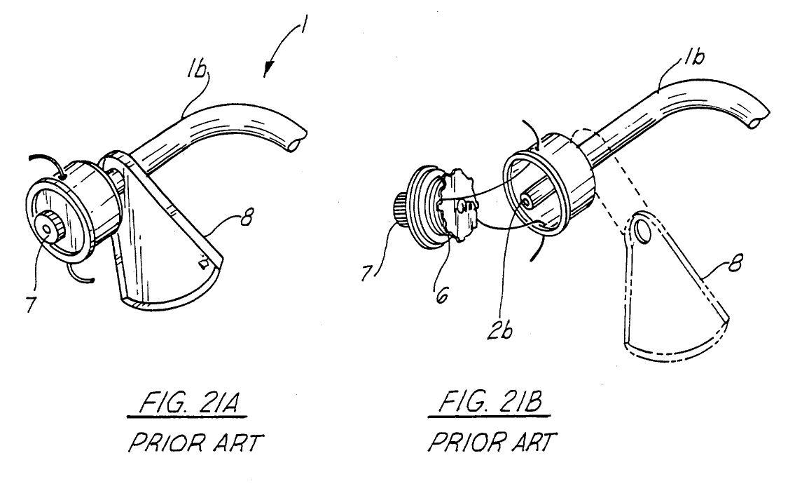

The blower implement 200 of FIG. 20 is of the disc or ring type (somewhat like that of FIG. 2B), with the ring 204 having either a solid bottom and a solid interior or an open bottom and open interior, as may be desired, with a concentrically located, axially extended, blower member 209. The radially extended blower member 209 has an outer ring 208 which surrounds and supports a series of radially extended, angled blower blades 207 and can be used to blow and drive various light materials about, such as, for example, cut vegetation, leaves and other like materials. When attached to the two-hand-held, powered device (la-Id) via the adapter 10, the blower member 209 with its blower blades 207 and ring 208 will be rapidly rotated and can be used to blow and move various light materials around, e.g., cuttings, leaves and other relatively light debris to a desired location or pick-up area.

The foregoing are exemplary of various tool implements, a number of which are quite innovative, that can be provided with the cultivator/adapter 10 or other adapter for turning a “Weed-Eater” device to a complete work and gardening system. It is noted that each of the implements 3-20 include upwardly extending, “snap” legs 31-201 which are used in similar fashion to the “snap” legs 21a/b of FIGS. 2A & 2B to attach its respective implement to the adapter 10 via the “snap” openings 14a/b.

Gardening Use of Converted Unit (1; 1a-1d)

The present invention is in one of its aspects primarily designed to provide safe removal of unwanted vegetation from, for example, underneath the ground, surrounding delicate flowers and shrubs, as well as plants, as well as many other applications. The cultivator/cutter implement 10 can be used to eliminate unwanted vegetation, especially “hard to get rid of” vegetation, by getting to the source of the problem. Regular use will ensure that unwanted vegetation will not appear anytime soon, leaving a beautiful garden area. This also ensures that the soil will receive the vital nutrients that the unwanted vegetation takes from the desirable plants. The implement 10 is preferably designed to work both as a cultivator, as well as a line trimmer.

The cultivator/cutter or trimmer 10 of the present invention can be used by disassembling a standard line trimmer spool type, powered unit 1 (FIG. 21; see also units 1a-1d of FIG. 1A-D) by removing, for example, the standard bump 7, spool 6 and spring (not seen in figure) used in such “Weed-Eater” type units. The typical line trimmer unit's guard 8 preferably is also temporarily removed to use the implement 10 or multi-implement system of the present invention.

For curved and straight shaft units 1a-1d, a top washer 4 [which can be, for example a one (1″) inch washer] or bushing is used to balance the implement 10. A bottom washer 5 [which can be, for example, a half (½″) inch washer] is used along with the either a nut or bolt as appropriate for the powered, hand-held unit. The right size of bolts 3b/3d and nuts 3a/3c, of course, should be used for the particular powered unit 1a-1d involved. It is believed that the cultivator/cutter/“adapter” 10, as described, should fit on approximately ninety-five (95%) percent of all gas trimmers. The bolts 3b/3d or nuts 3a/3c should not be forced, as the threads may be damaged.

In use for garden work, with the cultivator/cutter implement 10 attached to the powered, hand-held device (1a-1d) in a garden, the user can use both hands to start cutting around plants, vegetables, etc. The user can move, for example, backwards, slowing down power of the combined unit (e.g. 1a+10), and moving the combined unit left and right with the implement 10 held in a “flat” position.

The user should avoid contact with desirable plants, but, even if there is contact between the rotating side wall of the cylindrical body 11 of the implement 10, its curvature and the inward off-setting of the cultivator tines 16, often greatly reduce, if not eliminate, any significant damage to such plants, particular where the plant has a reasonably strong trunk or stem.

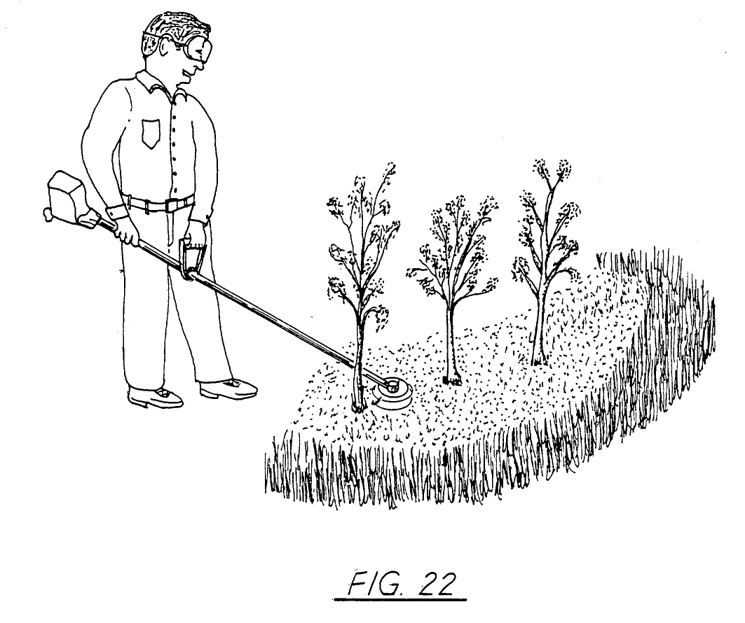

When the weeds are too high, the combined unit 1/10 should be set on top of them and the powered unit 1 accelerated gently. Additionally, for best results, the unit should be moved left and right more than once on top of the weeds. (See FIG. 22.)

The combined unit (e.g., 1b+10) should be used, for example, on a weekly basis for, for example, the first three weeks of use. After that period of time, it can be used whenever the user thinks it is necessary. The unit is best used when the ground is dry.

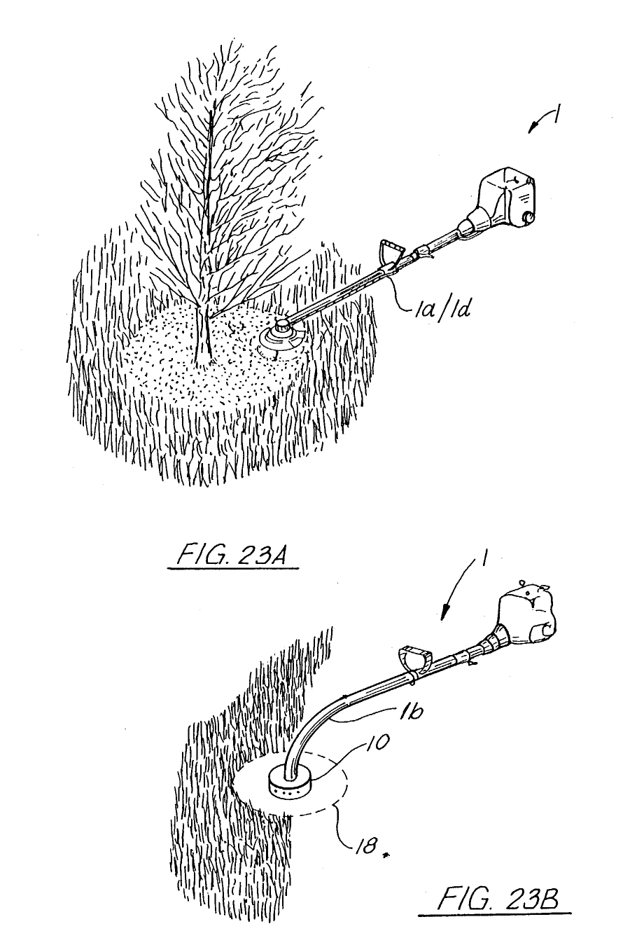

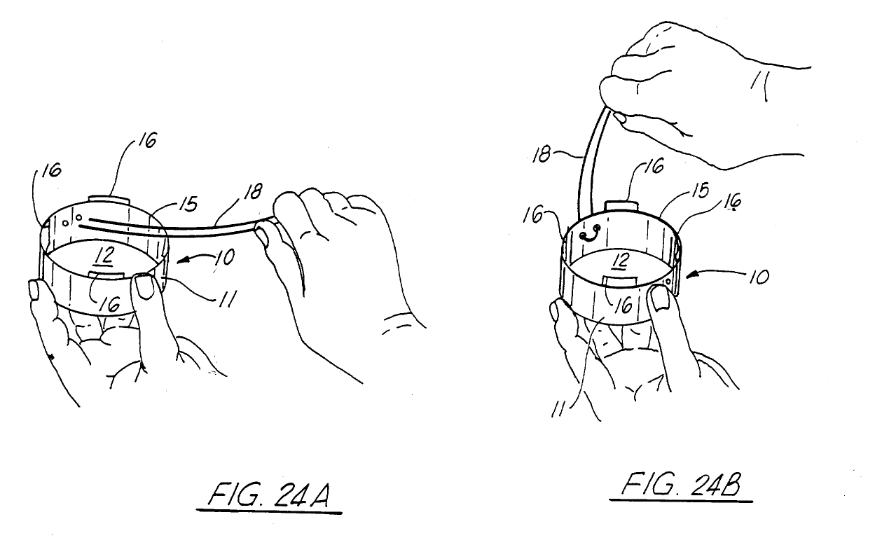

For an example of cutting weeds under ground, while protecting desirable plants, in the use of the exemplary cultivator embodiment 10 of the invention, note FIG. 23A. For an example of cutting grass as a line filament trimmer using filament line segments 18 placed in the hole sets 17, note FIG. 23B.

When it is time to initially add or replace the line filament segments 18, and with reference to FIGS. 24A & B, the ends of each of the line segment 18 are inserted through each set of holes from the inside of the implement body as seen in FIG. 24A, with the ends then being pulled through from the outside until they are fully extended out of the body 11 of the implement 10, as seen in FIG. 24B.

Alternative Cultivator Implement 300 & Cover Plate 400 (FIGS. 25-28)

With reference to FIGS. 25-27, another, alternative, exemplary, preferred embodiment 300 of the combined cultivator/filament-cutter implement of the present invention is illustrated and is similar to the combined cultivator/filament-cutter embodiment 10 of FIGS. 1 & 1A-1D. As can be seen, the side walls of the cylindrically shaped body 311 preferably are curved and smooth, with an alternative, cylindrically-stepped shape with preferably generally a solid top 312 extending over most of its top with, for example, the exception of the central unit attachment opening 313 and, if so provided, “snap-in,” “T” shaped openings (comparable, for example, to the openings 14 of FIGS. 1A-1D) circumferentially spaced about the periphery of the top 312. Further open areas could be provided in the top 312, if so desired, as long as the top had the necessary structural integrity and strength. Although the body 311 is preferably exactly cylindrical or cylindrically staged, some flaring of the side wall may occur, for example, in the manufacturing process which causes the body to be substantially cylindrical, but not exactly cylindrical, in its over-all, exterior shape.

The curved side wall of the body 311 preferably is relatively thin, continuous and of constant thickness, although some deviation of the body's side wall is possible as long as the deviation(s) do not significantly impede the movement and penetration of the side wall down into the ground in the implement's cultivator action and as long as the side wall has the necessary structural integrity and strength.

Additionally, peripherally spaced about its bottom 315 are a series of spaced, cultivator extension tines 316, along with a series of dual opening or hole sets 317 through which the ends of cutting filament line segments 318 are placed for cutting functions in the “Weed-Eater” fashion. An exemplary six (6) sets, three (3) on each side being illustrated, although more or less could be used, for further example, eight (8) or four (4) or two (2) [comparable to that shown in FIGS. 1A-1D], as may be desired. However, it has been found that multiple sets of at least four (4) or more sets is desirable for enhanced cutting life of the filament cutters, with, for example, four (4) lasting more than twice the life of two (2) sets, and six (6) sets, as illustrated, lasting more than three times the life of two (2) sets, thereby producing unexpected results.

The tines 316 form macerating protrusions having exterior side walls preferably inwardly offset a fraction of an inch from the exterior surface of the side wall (comparable to that shown in FIG. 1). When it is desired to use the implement 310 as a concurrent or separate filament line cutter, an appropriate number of line segments 318 are placed in the hole sets 317 as seen in FIGS. 25 & 26, in similar fashion to that further discussed above in detail in connection with FIGS. 24A & B.

An exemplary number of four (4) protrusions or tine blades 316, spaced from each at their centers at the circular body's ninety (90°) degree points, are illustrated, but a different number of them, of course, is possible (as noted above, for further example in connection with the tines 716 in connection with the implement 70 of FIG. 7). The protruding tines 316 generally form a “castellated” configuration with the flat, bottom edge 315 and can have inclined side(s) or a taper to aid in their penetration into the ground, however, preferably they are not so sharp as to cut into a human hand when being handled.

In cultivator use, the downwardly directed, circumferentially spaced, protruding tines 316 serve to provide spaced, ground entry and macerating projections, which provide a substantially improved cultivator action in comparison to that achieved by a circular cultivator that has only a single, continuous, entry edge extending without interruption about its three hundred and sixty (360°) degree scope, such as that shown in the Straayer '332 patent. In the exemplary embodiment 300, each of the four (4), preferably curved, downwardly protruding, integral, thin metal tine strips 316 can have, for example, an exemplary width of about three quarters (¾″) of an inch and a total height of about one and five-eights (1⅝″) of an inch, with an anchoring portion 316B of that being inserted into the slots 316A, with an outwardly, sidewardly and radially directed, bent metal, distal tip 316C. The outwardly directed tips 316C, preferably making a ninety (90°) turn or bend with the main body of the tine blades 316, also provide an enhanced, laterally or radially directed, side cutting action to the blade tines 316. As a safety feature, preferably the bent tips 316C do not extend past the outer circumference of the side wall of the body 311.

The preferably molded, integral body 311 can have an exemplary diameter of about three and three-quarters (3¾″) inches and a basic, main wall thickness of about a quarter (¼″) of an inch, while the metal tine blades can have an exemplary thickness of about nine-one-hundredths (0.09″) of an inch.

The cylindrical body 311 with its top 312 can be made of an integral body of, for example, molded material, as illustrated. Alternatively, it could be made of two, concentric sections with a castellated metal edge sandwiched between them. However, it is noted that the tines or protrusions 316 preferably are made of metal or other hard, rigid material that is made separately from the body 311, that is, they are not integrally molded with the main body 311, as in the embodiment 10 of FIGS. 1+. Indeed, as can be seen in FIGS. 25-27, the tines or protrusions 316 are separate items that are inserted into pre-formed, upwardly extending, preferably curved slots or cavities 316A (note FIGS. 26 & 27) formed in and though the bottom surface 315 and extending up into the side walls of the main body 311.

The lower body 316B of each tine 316 is secured in place down in its respective slot 316A by, for example, an attachment screw 319 (note FIG. 27) extending through pre-formed holes 316D & E and anchoring its pointed tip 319A into the interior of the body 311 of the implement. When a tine blade 316 is worn or otherwise needs to be replaced, the respective screw 319 is merely unscrewed, the worn tine blade removed and replaced with a new tine blade, and the screw 319 re-screwed into place. Other exemplary anchoring sub-systems for the tine blades 316 would be using a nut-and-bolt arrangement, with appropriate interior holes being preformed in the body 311 through the base protrusions 311C or a snap-in/snap-out arrangement provided, etc.

Preferably integrally formed with the main body 311 are rounded, longitudinally extended, exterior and interior, flanking set pairs of protrusions 311A 311B, respectively. Each set of extended protrusions 311A 311B flank and are located immediately adjacent to and extend past the side ends of its respective slot 316A and extend along the longitudinal depth of its respective slot, which combination serves to significantly strengthen and reinforce the body 311 in the areas where the interior tine slots 316A and their matching tine blades 316 are located and where such additional strength or reinforcement is very useful.

Additionally, an enlarged, interior body mass 311C located opposite to each of the holes 316D is included at the base area of each of the slots 316A to provide a sufficiently strong, anchoring area for the tip 319A of the screw 319. Each of the circumferentially extended, base protrusions 311C, extending between and preferably completely across its respective interior flanking protrusions 311B, also provide additional body strength or reinforcement to the body 311 in the slotted, holed areas of the body.

Also, a rounded, longitudinally extended protrusions 317A preferably are included at least on the exterior surface of the side wall of the body 311 between each spaced set of filament holes 317. In the six filament set total of holes 317 illustrated, this means that five (5) such rounded protrusions 317A are included on each three (3) filament set sides, with a filament protective rounded surface being provided adjacent to the end holes on each side by the adjacent exterior, rounded protrusions 311A. Thus, regardless of which way the filaments 318 are rotated or are whipped during use, each filament section 318 contacts a rounded surface, avoiding any ninety (90°) degree or sharp edges which could more rapidly wear out, break or cut the filament line, which is typically made of nylon or other artificial material.

It is noted that the rounded protrusions 317A longitudinally extends just above and just below the area of the holes 317, in comparison to the longitudinally extended strengthening protrusions 311A & 311B which extend almost the full height of the body 311. If so desired, like filament protective protrusions (analogous to 317A) could be provided on the interior surface of the body 311, with six (6) being used, one between each set of paired holes 317, so that the interior, mid-sections of the filament segments 318 rest on and mate with convex, curved, rounded surfaces, rather than the concave interior surface of the main body 311 with its relatively sharp-edges at the filament exist holes or eyelets 317.

If so desired, the top 312 of the body 311 could include snap-in openings, comparable to the openings 14 in the top 12 of the cultivator embodiment 10. This would then allow the body 311 to also serve as an adapter attachment for the exemplary, supplemental tool devices 20-200 discussed above in like fashion to their attachment to the adapter/cultivator embodiment 10.

The alternative, combined cultivator/filament-cutter implement 300 can be attached to a two-hand-held, long-handled type powered device like, for example, one of those shown in FIGS. 1A-1D, 21B, 22 and 23A & B, using the central opening 313, in the same manner as discussed above with respect to the central opening 13 of the initial embodiment 10. Alternatively, the implement 10 (300; along with a selected one of the supplemental attachments 20-200, if so desired) could be attached using the fastener assembly 1e to the working end of an exemplary, hand-gun-like-shaped, powered rotary drive 450 (note FIG. 29) used for one-hand or two-hand held, powered drills or powered screwdrivers, assuming the particular electric motor drive has sufficient power to adequately drive the implement 10/300 and any supplemental attached tool devices 20-200 to do the work intended for the attached tool devices. As is well known, such a hand-held, rotary powered device 450 includes a handle 451 and a distal chuck 452 fixedly connected to a rotary driven shaft 453 turned by an internal, electrical motor powered typically by an internal battery or a battery pack or by AC power.

With further reference to FIG. 29 and in similar fashion to the connecting to the long handle devices 1b & 1d described in connection with FIGS. 1B & 1D, respectively, a modified threaded bolt member 3b′, for example, similar to bolt 3b or 3d, but having an extended, distal, unthreaded, polygonal or circular, end section 3b″ having a polygonal or circular cross-section of a little bit lesser cross-sectional size than the diameter or cross-section of the lower, threaded section 3b′″, and being similar to the chuck engaging end of a drill bit or screw driving head designed to be used with the power tool 450 (for general background interest, note the Lidstone '771 patent cited above). In assembly, the washer 5 is placed on the body of the modified bolt 3b′ against its head, and the body of the bolt 3b′ with the washer in inserted through the opening 13 (313) and the washer 4 placed onto the threaded portion 3b′″ body of the bolt flush against the top of the opening 13 (313).

The nut 3c′ is then slid over and past the unthreaded, distal section 3b″ and then onto the threaded section 3b′″ and the nut then rotated until the bolt 3b′ and the body 11 (311) are secured together. Then the distal chuck end portion 3b″ is inserted into the chuck 452 when in its open disposition, and then the chuck is closed about the distal chuck end portion, securing the body 11 (311) to the powered drive 450. Upon actuation of the trigger 454, the cultivator/cutter 10 (300) can be used for its concurrent or independent cultivation/cutting actions, while the powered device 450 is held with one or two hands, as may suit the user.

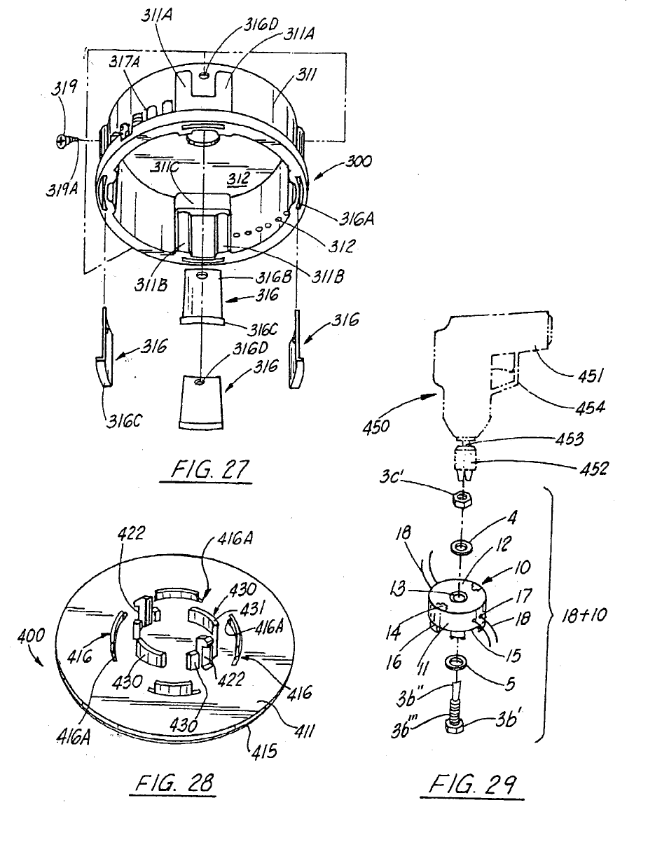

With reference to FIG. 28, a further exemplary, preferred feature of the present invention is the optional inclusion of a flat base, add-on, accessory member 400, preferably of the same or larger diameter [for example, a one (1″) inch greater diameter] than the outer diameter of the main body 311 of the cultivator implement 300. The protector plate 400 can be attached, when so desired, to the bottom of the rotary implement, particularly when the implement is the combined cultivator and filament cutter type 300 illustrated, for covering over and blocking the cultivator tines 316 from coming into macerating contact with the ground or desired vegetation when the implement is desired, for example, for use purely as a filament cutter device. The plate element 400 can also be used in storing the implement 300 between uses, protecting the tine blades 316 from damage or from damaging other things, including the user or others, as it is moved about and stored.

On the top side, namely the side facing the underside of the implement 300, of the circular plate body or disc 411, there is included a number of upwardly projecting members, namely, snap-in connecting legs 422 (similar in structure and function as legs 22), if openings like 14 are included in the top 312, for attaching the protector plate to the body 311. Upwardly extending off-sets or supports 430 are included whose distal, top surfaces 431 contact the underside of the top 312 for stability and support.

Most importantly, a set of spaced, curved slots 416 are provided th rough the thickness of the plate body 411 through which the blades 316 are inserted (but do not extend significantly out of or past) when the protective plate structure is being attached to the body 311. Side extensions 416A to the slots 416 are included, allowing the blades 316 to be axially inserted and then radially twisted into the side extensions, effectively locking the protective plate structure to the body 311. Thus, the protective plate structure 400 is temporarily attached (and easily removable from) through both the snap-in connection (422/14) and the insert and twist, blade/slot 316/416 connection. If the snap-in connection (422/14) is not present the insert and twist, blade/slot 316/416 connection is sufficient.

It is noted that the opposite, un-seen side 415 of the circular plate or disc 411 preferably is flat and smooth surfaced, so that it does no significant damage to the ground or vegetation it might come into contact with, as the “cultivator-but-now-only-a-cutter” implement is powered in rotary fashion, using only the filaments 318 for cutting work in a “Weed-Eater” type fashion. Although the bent tips 316C will to then be on the underside 415, they are in substantially flush engagement, not significantly disrupting the smooth underside surface of the plate body 411.

It should be understood that the foregoing dimensions, materials, variations and alternatives, etc., are merely exemplary, and many other changes are possible within the teachings of the present invention.

Thus, it is further noted that the embodiments of the cultivator/cutter implement and the multi-implement systems described herein in detail for exemplary purposes are of course subject to many different variations in structure, design, application and methodology. Because many varying and different embodiments may be made within the scope of the inventive concept(s) herein taught, and because many modifications may be made in the embodiments herein detailed in accordance with the descriptive requirements of the law, it is to be understood that the details herein generally are to be interpreted as illustrative and not in a limiting sense.

What is claimed is:

1. For use on a hand-held, powered device, a cultivator implement comprising:
an at least generally cylindrical, longitudinal extended body, having a hollow interior and an open bottom, a top, and a continuous, curved side wall with an exterior surface, an interior surface and a circular bottom;
a top affixed to said side wall at its top, substantially covering over said body, and having a relatively small diameter, central opening through which a threaded member for affixing the body to the powered device can be extended; and
a series of circumferentially spaced, castellated, cultivator protrusions affixed to and extending downwardly from said circular bottom of said body, said protrusions having exterior side walls inwardly offset a fraction of an inch from the exterior surface of said side wall, said protrusions serving to cultivate the ground and macerate unwanted vegetation when said cultivator implement is rotated by the powered device and the cultivator is lowered bottom first into the ground or unwanted vegetation.

2. The cultivator implement of claim 1, wherein:
said body is of molded material having a series of curved, longitudinally extended slots of a certain size and dimension extending into said side wall; and
wherein:
said cultivator protrusions are separately made and have an anchoring portion which is sized and dimensioned to fit into said slots for being secured to said body.

3. The cultivator implement of claim 2, wherein there are further included:
longitudinally extended reinforcing protrusions on at least one surface of said side wall flanking said slots.

4. The cultivator implement of claim 3, wherein there are further included:
longitudinally extended reinforcing protrusions on both the interior and the exterior surfaces of said side wall flanking said slots.

5. The cultivator implement of claim 1, wherein:
at least one of said cultivator protrusion has a distal bent tip extending outwardly laterally and radially, providing an outwardly, sidewardly directed cutting edge.

6. The cultivator implement of claim 5, wherein:
said bent tip does not extend past the outer circumference of said side wall.

7. The cultivator implement of claim 1, wherein:
said cultivator protrusions are curved in their lateral cross-section, following the curvature of said side wall.

8. The cultivator implement of claim 1, wherein:
said cultivator protrusions are made of stamped metal.

9. The cultivator implement of claim 1, wherein there is further included:
multiple sets of circumferentially spaced opening pairs in said side wall, into which filament segments are placed, one segment for each opening pair, with the ends of each segment extending out past the exterior of said side wall, allowing the ends to be used as filament cutters when said cultivator implement is rotated by the powered device and the cultivator is lowered bottom first into vegetation or grass.

10. The cultivator implement of claim 9, wherein there are further included:
a longitudinally extended, rounded protrusion on the exterior surface of said side wall positioned between each one of said opening pairs, providing curved surfaces to the adjacent filaments as they move in contact with said rounded protrusions.

11. The cultivator implement of claim 1, wherein:
said top of said body includes a set of multiple, circumferentially spaced “snap-in” openings; and
wherein:
there are a multiple number of additional, different implements capable of performing different work functions from one another, each of said implements including a series of upwardly directed extensions spaced from one another on each implement comparably to said snap-in” openings and having a length allowing said cultivator implement to be also used as a “universal” adapter by the extensions of each additional implement being easily and quickly “snapped-in” and “snapped-out” of the openings for replacing one of the additional implements with another in quick and easy fashion without the use of any tools.

12. The cultivator implement of claim 1, wherein:
said cultivator protrusions, said body and said top of said body form an integral body of molded material.

13. The cultivator implement of claim 1, wherein there is further included:
a protective, bottom plate member having a series of circumferentially spaced slots though it in a pattern substantially identical to the pattern formed by said series of circumferentially spaced, castellated, cultivator protrusions and of a size and dimension to allow said cultivator protrusions to fit them, the underside, bottom surface of said bottom plate member being flat, said member serving to cover said cultivator protrusions.

14. The cultivator implement of claim 1, wherein there is included one or more of the other innovative, “unobvious” features disclosed in the foregoing specification.

15. For use on a hand-held, powered device, a cultivator implement comprising:
an at least generally cylindrical, longitudinal extended body, having a hollow interior and an open bottom, a top, and a continuous, curved side wall with an exterior surface, an interior surface and a circular bottom, said body being of molded material and having a series of curved, longitudinally extended slots of a certain size and dimension extending up into said side wall;
a top affixed to said side wall at its top, substantially covering over said body, and having a relatively small diameter, central opening through which a threaded member for affixing the body to the powered device can be extended; and
a series of circumferentially spaced, castellated, cultivator protrusions affixed to and extending downwardly from said circular bottom of said body, said protrusions having exterior side walls, said cultivator protrusions being separately made and having an anchoring portion which is sized and dimensioned to fit into said slots for being secured to said body, said cultivator protrusions being curved in their lateral cross-section, following the curvature of said side wall, at least one of said cultivator protrusions having a distal, bent tip extending outwardly laterally and radially, providing an outwardly, sidewardly directed cutting edge, said protrusions serving to cultivate the ground and macerate unwanted vegetation when said cultivator implement is rotated by the powered device and the cultivator is lowered bottom first into the ground or unwanted vegetation.

16. The cultivator implement of claim 15, wherein:
said cultivator protrusions are made of stamped metal.

17. The cultivator implement of claim 15, wherein there are further included:
longitudinally extended reinforcing protrusions on both the interior and the exterior surfaces of said side wall flanking and overlapping said slots.

18. The cultivator implement of claim 15, wherein there is further included:
multiple sets of circumferentially spaced opening pairs in said side wall, into which filament segments are placed, one segment for each opening pair, with the ends of each segment extending out past the exterior of said side wall, allowing the ends to be used as filament cutters when said cultivator implement is rotated by the powered device and the cultivator is lowered bottom first into vegetation or grass.

19. The cultivator implement of claim 18, wherein there are further included:
a longitudinally extended, rounded protrusion on the exterior surface of said side wall positioned between each one of said opening pairs, providing curved surfaces to the adjacent filaments as they move in contact with said rounded protrusions.

20. The cultivator implement of claim 15, wherein there is further included:
a protective, bottom plate member having a series of circumferentially spaced slots though it in a pattern substantially identical to the pattern formed by said series of circumferentially spaced, castellated, cultivator protrusions and of a size and dimension to allow said cultivator protrusions to fit them, the underside, bottom surface of said bottom plate member being flat, said member serving to cover said cultivator protrusions.

21. For use on a hand-held, powered device, a tool implement comprising:
an at least generally cylindrical, longitudinal extended body, having an interior and a bottom, a top, and a continuous, curved side wall with an exterior surface, an interior surface and a circular bottom;
a top affixed to said side wall at its top, substantially covering over said body, and having a relatively small diameter, central opening through which a threaded member for affixing the body to the powered device can be extended; and
a tool work section connected to said body, said tool work section serving to do useful work when said body is rotated by the powered device and the tool work section is lowered bottom first into engagement with an external surface on which work is to be performed.

22. The tool implement of claim 21, wherein there is included one or more of the other innovative, “unobvious” features disclosed in the foregoing specification in connection with FIGS. 2A-20.
